(19) United States
(12) Patent Application Publication
(10) Pub. No.: US 2008/0025389 A1
(43) Pub. Date: Jan. 31, 2008

(54) Method and Apparatus for False Sync Lock Detection in a Digital Media Receiver

(76) Inventors: Ivonete Markman, Carmel, IN (US); Weixiao Liu, Indianapolis, IN (US); Thomas Edward Horlander, Indianapolis, IN (US); Matthew Thomas Mayer, Indianapolis, IN (US)

Correspondence Address: THOMSON LICENSING LLC, Two Independence Way, Suite 200, PRINCETON, NJ, 08540, US

(21) Appl. No.: 10/560,413

(22) PCT Filed: Jun. 16, 2004
(86) PCT No.: PCT/US04/19357

§ 371 Date: Mar. 22, 2007

Related U.S. Application Data
(60) Provisional application No. 60/479,395, filed on Jun. 18, 2003.

(51) Int. Cl. H04N 7/12

(52) U.S. Cl. 375/240.02

(57) ABSTRACT

A method and apparatus for identifying a false MPEG-2 packet synchronization lock condition by parsing MPEG-2 packets that may have been incorrectly delineated by a sync-byte checksum-decoder, to detect resulting anomalies. Forcing the restart of the conventional checksum-encoded sync-byte synchronization/lock process upon generating a “resync” command based upon the anomalies detected by a False Lock Detector. Reliably synchronizing and delivering the MPEG-2 stream to the receiver transport layer. The False-Lock Detector circuit compares the content of the currently identified packet header or payload portion of a sync-byte delineated packet with expected values in order to detect a false-lock condition and to eliminate false sync-byte position-candidates from the basis of a “synchronization lock”.

### CROSS-REFERENCE TO RELATED APPLICATION

This application claims the benefit of U.S. Provisional Application Ser. No. 60/479,395 (Attorney Docket No. PU030167), filed Jun. 18, 2003, and entitled “METHOD AND APPARATUS PROCESSING NULL PACKETS IN A DIGITAL MEDIA RECEIVER”, which is incorporated herein by reference in its entirety.

### FIELD OF THE INVENTION

The present invention relates to transmitting and receiving multimedia data including digital video and audio, and more particularly to a method and apparatus for reliably synchronizing and delivering an MPEG-2 stream broadcast over such a digital transmission system to the receiver transport layer by feeding back information from the receiver transport layer to the receiver physical layer.

### BACKGROUND OF THE INVENTION

Digital transmission systems offer consumers high-quality multimedia data including compressed audio and video streams. For broadcasters, the compression of data allows for several digital channels to be delivered over the same bandwidth required for fewer analog channels. The audio and video components of a program are compressed at the source and time-multiplexed with other programs and system information needed to recreate the original program. The digital multiplex is processed by a physical layer and transmitted to the consumer. At the consumer end, the receiver processes the signal to recover the multiplexed digital streams, extracts the program of interest, and decodes the compressed audio and video for presentation on a video/audio display such as a television.

To promote the development of interoperable components from different manufacturers, the MPEG-2 international compression and multiplexing standard was developed. The standard does not specify the techniques for encoding, multiplexing, and decoding the bit streams, but only the format of the data. This leaves an opportunity for manufacturers to differentiate their products through the way in which they use resources such as silicon, processor power, and memory, and through their ability to conceal or recover from errors.

In the MPEG-2 standard, digitized video, audio and other forms of data streams, termed elementary bit streams, are first formed into variable-length packet elementary streams (PES packets). In a transport stream, PES packets including the PES headers from the various elementary bit streams are carried as a payload within fixed-length transport (TS) packets. Each PES packet for a particular elementary bit stream would then occupy a variable number of transport packets.

The transport packets are 188 bytes long transmitted in serial fashion, most significant bit (MSB) first and always start with a packet header. The remainder of the packet carries data known as the payload. The TS packet header is 4 bytes long, but for special purposes the header may be extended by an adaptation field (adaptation header). The header of each packet contains fields for packet synchronization and identification, error indication, and conditional access. The packet's payload may follow immediately after the header or after an adaptation field. The payload (1496 bits) can contain any multimedia data including compressed video and audio streams.

The transport packet header begins with one synchronization byte (called the “sync byte” and having a constant value of 47 Hex), and contains three subsequent bytes containing service identification, scrambling and control information. The four-byte transport packet header is followed by 184 bytes of MPEG-2 payload (and/or auxiliary) data. The transport packet header is structured as follows:

a) Sync byte: 8 bits consisting of a fixed value of 0×47 (47 Hex)

b) Transport_error_indicator: 1 bit indicating an uncorrectable bit error in the current transport packet. This information may be set by the transmitter or the receiver. 0: no errors; 1: uncorrectable errors.

c) Payload_unit_start_indicator: 1 bit indicating the presence of a new PES (Packetized Elementary Stream) packet or a new PSI (Transport Stream—Program Specific Information) section.

d) Transport_priority: 1 bit indicating a higher priority than other packets.

e) PID: 13-bit packet ID. Values 0 and 1 are preassigned, while values 2 to 15 are reserved. Values 0×0010 to 0×1FFE may be assigned by the Program Specific Information (PSI). Value 0×1FFF is for null packets.

f) Transport_scrambling control: 2 bits indicating the scrambling mode of the packet payload.

g) Adaptation_field_control: 2 bits indicating the presence of an adaptation field or payload. ‘00’: Reserved; ‘01’: payload only; ‘10’: adaptation field only; ‘11’: adaptation field and payload. h) Continuity_counter: 4 bits, representing one continuity_counter per PID. It increments with each non-repeated transport stream packet having the corresponding PID. If two consecutive transport packets with the same PID have the same value and the adaptation_field_control equals ‘01’ or ‘11’, the two transport packets are considered duplicates. The continuity_counter is not incremented for packets with adaptation_field_control of ‘00’ or ‘10’.

The 13-bit PID (packet ID) corresponds to a particular elementary stream of video, audio, or other program element. PID 0×0000 is reserved for transport packets carrying a program association table (PAT). A broadcast MPEG-2 stream may contain several multiplexed programs of audio and video data, along with the necessary system data, and each packet of data is identified by its unique PID within the packet header but there may be many packets from other programs in between packets of a given PID. To help the MPEG-2 demultiplexer, the packet link header contains a continuity count. This 4-bit value increments at each new packet having a given PID and wraps around to zero.

In a transport stream, each elementary stream has a different PID, but the demultiplexer has to be told which PIDs correspond to which program before it can operate. This is the function of the Program Specific Information (PSI). Program Specific Information is the MPEG-2 data that identifies the parts of the transport stream (PIDs) that belong to a particular program. This information is carried in a number of PSI tables:

1) Program Association Table (PAT) (required) The Program Association Table (PAT) is the entry point for the Program Specific Information (PSI) tables. It is always carried in packets with PID (packet ID)=0. For each assigned program number, the PAT lists the PMT-PIDs (PID for packets containing that program's PMT).

2) Program Map Table (PMT) (required) The PMT lists all the PIDs for packets containing elements of a particular program (audio, video, aux data, and Program Clock Reference (PCR)).

3) Conditional Access Table (CAT) (optional) The CAT is always carried in packets with PID=1. The CAT contains PIDs for Entitlement Management Messages (EMMs), which contain authorization level information for conditional access systems.

4) Network Information Table (NIT) (optional) The PAT also contains the PIDs for the NIT(s). The NIT is an optional table that maps channel frequencies, transponder numbers, and other guide information for programs.

The PAT is the list of programs. The individual programs are described in subdirectories, the PMTs (program map tables). The program to be decoded is specified by selecting a PMT, the PIDs of which must all be listed in the PAT.

The PAT points to a Program Map Table (PMT), which in turn points to particular elements (PIDs) of a program. The PAT is transmitted at regular intervals and contains a list of all the programs in this transport stream, each program with a corresponding program PID. The packets associated with this program PID (PMT-PID) contain the Program Map Table (PMT), which fully describe a program by listing the PID's of each video, audio and data stream contained in this program. Consequently, when the viewer selects a particular program, the MPEG-2 demultiplexer/decoder looks up the program number in the PAT, finds the right PMT and reads the video, audio and data PID's. It then selects transport packets having these PID's from the transport stream and routes them to the decoders. For data protection, PAT and PMTs are transmitted together with a CRC (cyclic redundancy check) sum.

In general, an MPEG-2 demultiplexer/decoder receiver system consists of three main functions: a transport demultiplexer, an audio decoder and a video decoder. An MPEG-2 demultiplexer/decoder receiver system is adapted to:

1. reading the PAT to find the PMT for a desired program,

2. demultiplexing the packets that carry the desired PMT

3. reading the PMT

4. demultiplexing the packets (having PIDs specified in the PMT) into the various elemental streams

Demultiplexing a MPEG-2 transport stream thus involves:

1) finding the PAT by selecting packets with PID=0×0000

2) reading the PIDs for the desired PMT

3) reading the PIDs for the elements of a desired program from its PMT (for example, a basic program will have a PID for audio and a PID for video)

4) detecting packets having the desired PIDs and routing them to the decoders.

The MPEG-2 transport demultiplexer/decoder, commonly referred to as “the transport”, monitors the stream based on packet boundaries (delineated by the sync bytes identified in the framing block) so that the packet's fields can be processed, and demultiplexes the packets from the incoming transport stream into the video and audio streams for a given program, and also extracts the system data. The compressed audio and video data streams are sent to the audio and video decoders, respectively.

When an MPEG-2 demultiplexer/decoder receiver system powers up, it knows nothing about the content of an incoming transport stream except that it must search for packets having a PID of zero. (PID zero is reserved for the program association table (PAT).) In order to find and read a PID in the header of a packet, the sync-bytes of packets in the stream must have been reliably identified (in the framing block), to establish a true MPEG-2 “synchronization lock”. When the sync byte position of a packet has been correctly identified, the decoder stores and checks the data content of the transport-stream packets. In a next step it searches for the transport-stream tables, the most important of which is the PAT (program-association table) which is assigned the packet identification (PID) number 00 hex, and describes all programs in the transport stream.

The MPEG-2 sync byte is intended to facilitate packet delineation at the decoder. However, unlike many other digital transmission standards, the method used for MPEG-2 synchronization in the digital cable transmission system physical layer is de-coupled from the Forward Error Correction (FEC) synchronization. First, the MPEG-2 packet does not contain an integer number of FEC frames, or even Reed-Solomon (RS) codewords. Reed-Solomon (RS) Coding, using a (128, 122) code, provides block encoding and decoding to correct up to three 7-bit symbols within an RS block. Hence, the MPEG-2 packets and the FEC frames, or the MPEG-2 packets and RS codewords are asynchronous with respect to each other. Second, the sync byte is replaced inside the MPEG framing block at the transmission site by a parity checksum that is a coset of an FIR parity check linear block code.

Hence, the MPEG framing block at the receiver site needs to decode this parity check block code in order to recover the sync byte and then lock to it. It then delivers MPEG packet synchronization to the downstream receiver blocks, including the MPEG-2 demultiplexer/decoder. The output of the framing block may include an output clock, the data stream, in serial or parallel format, a “sync” signal identifying the supposed position of the sync byte in the data stream, a “valid” signal identifying when data is present at the output data stream and an “error” signal identifying whether the packet is considered invalid (uncorrectable errors) or error free.

The ANSI/SCTE 07 2000 (formerly SCTE DVS 031) and ITU-T J.83B standards, which are nearly identical, describe a digital transmission system for cable distribution of video, sound and data services. In particular, the ANSI/SCTE 07 2000 standard describes the adopted standard for digital cable transmission in the U.S. In both standards, the data format input to the physical layer (channel coding and modulation) is assumed to be MPEG-2 transport.

In the physical layer, the MPEG framing is the outermost layer of processing. At the transmitter, the MPEG framing block is followed by the Forward Error Correction (FEC) encoder and the 64 or 256 Quadrature Amplitude Modulator (QAM). An FEC system is a class of methods for controlling errors in a one-way communication system such as an MPEG-2 stream. An FEC encoder sends extra information along with the data, which can be used by the receiver to check and correct the data. The FEC encoder consists of concatenated systems including a Reed-Solomon (RS) encoder, an interleaver capable of several modes, a randomizer and a trellis encoder. It produces high coding gain at moderate complexity and overhead. The FEC system is optimized for quasi error free operation at a threshold output error event rate of one error event per 15 minutes. At the receiver, the corresponding functions of demodulation and FEC decoding are performed, followed by the MPEG framing block, which delivers an MPEG-2 transport stream to the MPEG-2 demultiplexer/decoder.

The sync-byte is encoded as a checksum to make use of the information bearing capacity of the sync byte. At the transmitter, a parity checksum, which is a coset of an FIR (finite impulse response) parity check linear block code (LBC or FIR-PCC), is substituted for this sync byte, supplying error detection capability independent of the FEC layer. The parity checksum is computed over the adjacent 187 bytes, which constitute the immediately preceding MPEG-2 packet content (minus sync byte). The parity checks of the block code are computed at the receiver by observing the output of a finite impulse response (FIR), linear time-invariant (binary) filter. The checksum is computed at the receiver by passing the 1496 payload bits through a linear feedback shift register (LFSR) which allows for a computationally efficient implementation of the parity check FIR filter, in a recursive manner, that is generally self-synchronizing and therefore supports simultaneous packet synchronization and error detection. The decoder computes a sliding checksum on the serial data stream, using the detection of a valid code word to detect the start of a packet.

The code has been designed such that when the appropriate 188 bytes of bitstream (including the checksum) are multiplied against the parity check matrix, a positive match is indicated when the calculated product produces a 47 Hex result. (Note that the checksum is calculated based on the previous 187 bytes and not the 187 bytes yet to be received by the MPEG-2 sync decoder. This is in contrast to the conventional notion of an MPEG packet structure, in that the sync byte is usually described as the first byte of a received packet.)

This synchronization de-coupling feature of MPEG-2 was intended to introduce the flexibility, for example, to enable the system to carry Asynchronous Transfer Mode (ATM) packets easily without interfering with ATM synchronization. However, an unintended consequence of this feature is the increased probability of “false (synchronization) locks” in the synchronization detector of the prior art within the MPEG framing block (see FIG. 1).

FIG. 1 shows an example of a prior art MPEG framing block 200 at the receiver end. As shown in FIG. 1, the output of this block 200 may include the “Data_out” stream (in serial or parallel format), a “sync” signal (Sync_flag) identifying the position of the sync-byte in the “Data_out” stream, and an “error” signal (Error_flag) identifying whether the packet is considered invalid (uncorrectable errors) or error-free, as determined by the regular detection of the sync-byte checksum by the Syndrome Detector 220. Outputs of the MPEG framing block 200 may also include (not shown) an output “clock”, and a “valid-data” signal identifying when data is present at the output “data” stream.

The data stream input to the MPEG framing block 200 at the receiver end is serialized (Serial Data Stream) and is sent through the Syndrome Generator 210. Following the Syndrome Generator 210, the Syndrome Detector 220 compares the Syndrome Generator's 210 output with 47 Hex for a number of packets, N, and a programmable threshold, synd_thresh, establishes whether a sync-byte has actually been detected. For example, if during N packets, the number of Syndrome Generator 210 outputs equal to 47 Hex is greater than or equal to synd_thresh, then a sync-byte has been detected. A Lock_flag indicates whether or not periodic sync-bytes have been detected within the data stream, for example, by being 1 or 0, respectively. A Sync_flag indicates the sync-byte position within the data stream by, for example, being 1 during the sync-byte and 0 otherwise. Once a locked alignment condition is established, the absence of a valid code word at the expected location in the Serial Data Stream will indicate a packet error. The Error_flag of the previous packet can then be set to 1; otherwise, the packet is considered error free and the Error_flag is set to 0. In the absence of a locked condition, the Error_flag may be set to 1.

On a parallel path, the original data stream is appropriately delayed (see Delay 230 in FIG. 2) and is sent to the MPEG Sync Re-insertion block 240 where the predetermined sync-byte value is inserted in place of the parity checksum that was created at the transmitter-end MPEG framing block. Hence, the output data stream (Data_out) output by the receiver-end MPEG framing block 200 is a restored standard MPEG-2 transport stream. This data output (Data_out) can be in either serial or parallel mode. Two additional signals not shown in FIG. 2 are also sent to the transport layer: the “clock” and the “valid” or “enable” signal associated with the data.

After a (synchronization) lock detection, the MPEG sync re-inserter 240 within the MPEG framing block 200 of the prior art inserts the predetermined sync-byte value into the sync-byte position identified by the parity check block decoder, outputs the Sync_flag signal, the Error_flag signal, the valid and clock signals, and sends the data stream (and the Error_flag) to the transport layer. The Sync_flag and the Error_flag sent to the transport layer are the same as created by the syndrome detector 220.

False (synchronization) locks in the syndrome detector of the prior art within the MPEG framing block 200 can occur because the parity check block code is not very powerful and its decoder may indicate several locations in a packet where a possible sync byte seems to be found, when only one is the correct location. This occurs even when the FEC is perfectly locked and delivers an error free data stream.

A section of the MPEG-2 data stream could be heavily biased in a particular PID, or evenly weighted across many PIDs, or could contain a high percentage of null packets. Errors, known and unknown, are inherent in transport stream delivery and can occur at any time. Unknown errors such as bit corruption or data loss can occur at any bit position of the stream, and may mislead the transport into unusual behavior.

Repetitive null packets may cause the syndrome detector within the MPEG framing block of the prior art to lock to the wrong synchronization position, thereby producing invalid MPEG-2 packets to the transport block even when the FEC is perfectly locked and delivers an error free data stream. In the case of a periodic data stream, such as a data stream having a considerable number of null packets, for example, this problem becomes acute and the lock detector (syndrome detector) of the prior art may falsely lock to one of several wrong sync byte positions in the packet as identified by the parity check block decoder (210 and 220) and send invalidly delineated packets to the transport block even when the FEC is perfectly locked and delivers an error free data stream. As long as there are enough null packets multiplexed in the data stream on a regular basis, this may be enough to keep the lock detector falsely locked for a long time.

In the case of a false lock, the transport layer may still try to process an incorrectly synchronized packet, since it may still be receiving 188 data bytes, with a first byte being falsely identified as the sync byte, a valid signal in line with the sync byte, and error signal indicating an error free packet, and thus a false lock condition may mislead the transport into unusual behavior.

### SUMMARY OF THE INVENTION

The present invention provides a method and apparatus for detecting a false synchronization lock condition (and for reliably synchronizing and delivering the MPEG-2 stream to the receiver transport layer) through parsing and analysis of packet contents other than the sync byte such as Program Specific Information and packet header fields. A False-Lock Detector circuit may be provided to compare the content of the currently identified packet header or payload portion of a sync-byte delineated packet with expected values in order to detect a false-lock condition or to verify the current sync-byte position-candidate, and to eliminate false sync-byte position-candidates from the basis of a “synchronization lock”. If a current sync-byte position-candidate is rejected, a new sync-byte position-candidate may be in turn selected (subject to verification by the False Lock Detector as before) based upon the position of the checksum-encoded sync-byte detected within the header portion of one or a plurality of null-packets in the stream.

An embodiment of the present invention provides an apparatus for processing a stream of fixed-length packets received as digitally encoded signals and having multiple packet types, each packet including a header portion, the header portion containing a checksum-encoded synchronization-byte, the apparatus comprising: a synchronization-byte detector for detecting position-candidates of a checksum-encoded synchronization-byte in each packet, and for periodically outputting a synchronization-byte position signal at a first detected position within each packet, wherein the Synchronization Detector is adapted to respond to a “resync” command signal by trying to detect a checksum-encoded sync-byte in a second position within each packet. The apparatus may further comprise a False Lock Detector adapted to generate and assert the “resync” command signal because at least one predefined anomaly condition that indicates a possible false-lock condition has been detected. The predefined anomaly conditions may be selected from detectable anomalies known or discovered to be associated with false locks, include the following anomaly conditions a) through e):

a) a MPEG-2 PAT table has not been detected in the stream;

b) a MPEG-2 PMT table has not been detected in the stream

c) at least one of the MPEG-2 PID's listed in a MPEG-2 PMT has not been detected in the stream;

d) a discontinuity in at least one MPEG-2 continuity counter for MPEG-2 packets in the stream has been detected;

e) the value of the MPEG-2 transport_error_indicator bit detected in a MPEG-2 packet's header is “1” while the MPEG-2 Error_flag bit is “0.”

The apparatus may further comprise a Decision Logic circuit adapted to generate the “resync” command signal in response to the detection of a dynamically defined selection of one or more of the predefined anomaly conditions (e.g., anomaly conditions a) through e) )

A second embodiment of the present invention provides an apparatus for processing a stream of fixed-length packets received as digitally encoded signals and having multiple packet types, each packet including a header portion, the header portion containing a checksum-encoded synchronization-byte, the apparatus comprising: a False Lock Detector adapted to generate a “resync” command signal because at least one predefined anomaly condition that indicates a possible false-lock condition has been detected. The apparatus further comprises a synchronization-byte detector for detecting position-candidates of a checksum-encoded synchronization-byte in each packet, and for periodically outputting a synchronization-byte position signal at a first detected position within each packet. The Synchronization Detector is adapted to respond to the “resync” command signal by trying to detect and to “lock” to a checksum-encoded sync-byte in a second position within each packet.

A third embodiment of the present invention provides a method for processing a stream of fixed length packets each packet containing a checksum-encoded sync-byte, the stream including a plurality of packets that each contain a first fixed bit pattern in the header portion of each packet, the method comprising: performing a first detection step of decoding the checksum in the stream to detect a checksum-encoded sync byte position-candidate in the stream; and performing a false lock detection step including detecting at least one anomaly that indicates a possible false synchronization lock; and then

performing a second detection step of decoding the checksum in the stream to detect a second checksum-encoded sync byte position-candidate in the stream. The method may further comprise the intermediate step of generating a “resync” command signal having a value indicating that a possible false synchronization lock has been detected, and outputting that “resync” flag signal value to a synchronization-byte detector adapted to respond to the “resync” command signal value by trying to detect and resynchronize to the next position-candidate of a checksum-encoded synchronization-byte using the conventional checksum detection process.

A fourth embodiment of the present invention provides a computer program product for a set-top-box that comprises a set of instructions, which, when loaded into the set-top-box, causes the set-top-box to carry out the above described method for processing a stream of fixed length packets.

A fifth embodiment of the present invention provides a computer program product for a television set that comprises a set of instructions, which, when loaded into the television set, causes the television set to carry out the above described method for processing a stream of fixed length packets.

These and other aspects, features and advantages of the present invention will become apparent from the following description of exemplary embodiments, which is to be read in connection with the accompanying drawings.

### BRIEF DESCRIPTION OF THE DRAWINGS

The above features of the present invention will become more apparent by describing in detail exemplary embodiments thereof with reference to the attached drawings in which:

FIG. 1 is a block diagram of a prior art MPEG-2 framing block at the receiver end of a digital transmission system;

FIG. 2 is a block diagram of a MPEG-2 framing block and a False Lock Detector according to a first embodiment of the present invention;

FIG. 3 is a block diagram of a False Lock Detector according to a second embodiment of the present invention;

FIG. 4 is a flowchart describing an algorithm performed to generate the PAT flag used by the Decision Logic Blocks 542 and 542-A of FIGS. 2 and 3 respectively according to an embodiment of the present invention; and

FIG. 5 is a flowchart describing an algorithm performed to generate the PMT_flag used by the Decision Logic Blocks 542 and 542-A of FIGS. 2 and 3 respectively according to an embodiment of the present invention.

### DETAILED DESCRIPTION OF PREFERRED EMBODIMENTS

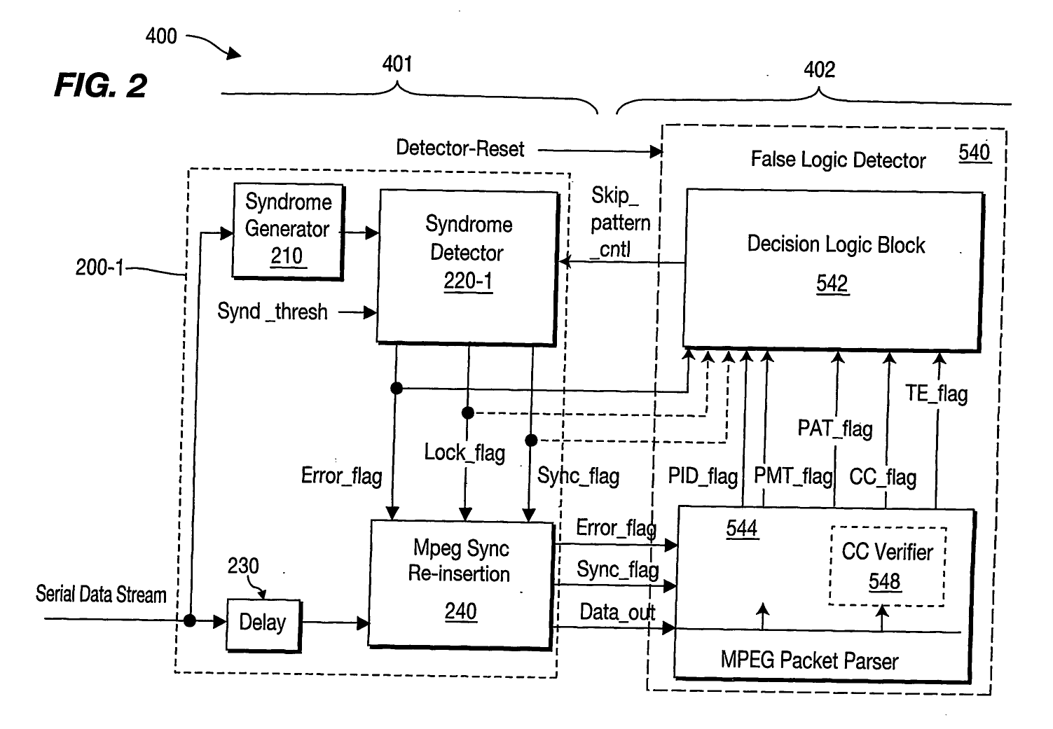

FIG. 2 is a block diagram showing a MPEG-2 framing block 200-I including a Syndrome Detector 220-I adapted to receive and to comply with a “resync” (resynchronize) command skip_pattern_cntl by unlocking and by trying to locate a (different, subsequent) sync-byte position-candidate (different from the detected sync-byte position currently locked to), and to lock to that different detected sync-byte position. The False Lock Detector 540 generates and outputs the skip_pattern_cntl command to the Syndrome Detector 220-I.

As previously mentioned, since the parity check block code in the MPEG framing block (200-I) is not very powerful, its decoder (210) may indicate several positions in a packet (position-candidates) where a possible sync byte could be found, when only one position is the correct one, and the Syndrome Detector 220-I may false lock and output a false Sync_flag, a false Error_flag and a false Lock_flag.

The False Lock Detector 540 is adapted to detect a false synchronization lock condition of the Syndrome Detector 220-I and to output a “loss of synchronization”/“resync” command (skip_pattern_cntl) to the Syndrome Detector 220-I. The Syndrome Detector 220-I is adapted to respond to that command by unlocking and trying to resynchronize, that is, to try to detect another (the true) sync-byte position candidate indicated by the parity check block decoder (Syndrome Generator 210) and by the Syndrome Detector 220-I and to lock on to that (new) detected position. This process of unlocking and resynchronization may repeat until the correct sync-byte position is found (e.g., when no anomaly or insufficient anomalies indicating a false-lock condition is/are detected by the False Lock Detector 540).

When the “resync” command (skip_pattern_cntl) is asserted, the Syndrome Detector 220-I enters a “resync phase” (resynchronization phase) and restarts the conventional process of detecting a checksum-encoded sync-byte. The operation of the Syndrome Detector 220-I, during the “resync phase” (resynchronization phase) may be identical to the conventional synchronization process of detecting a checksum-encoded sync-byte performed in the Syndrome Detector 220 of the related art.

The False Lock Detector 540 declares a loss of synchronization by the assertion of the skip_pattern_cntl signal when one or more anomalies are detected in the Serial Data Stream as delineated by the current sync-byte position lock. A distinct resynchronization-enabling signal separate from skip_pattern_cntl is not required to restart the synchronization process (to start the resynchronization process) once the “loss of synchronization” signal (skip_pattern_cntl) has been asserted by the False Lock Detector 540. When the Syndrome Detector 220-I finds a synchronization-byte (periodically) at a (new) location in the stream, the system returns to the lock phase, through detection of a checksum-encoded synchronization-byte as is typically performed by the Syndrome Detector 220 of the related art. The return of the Syndrome Detector 220-I to the lock phase may depend upon the occurrence of an uninterrupted series of detections of the checksum-encoded synchronization-byte at the same (periodic) position, each detection of said synchronization-byte occurring at intervals of time equal to the time required for an entire packet length of data to flow through the Syndrome Detector 220-I.

After the “loss of sync”/“resync” (skip_pattern_cntl) signal is asserted, the Syndrome Detector 220-I compares the Syndrome Generator's 210 output with 47 Hex for a number of packets, N, and a programmable threshold, synd_thresh, establishes whether a sync-byte has actually been detected. For example, if during N packets, the number of Syndrome Generator 210 outputs equal to 47 Hex is greater than or equal to synd_thresh, then a sync-byte has been detected. A Lock_flag indicates whether or not regular periodic sync-bytes have been detected in packets within the data stream, for example, by being 1 or 0, respectively. A Sync_flag indicates the detected position of the detected checksum-encoded sync-byte within each packet in the data stream by, for example, (e.g., being 1 during the sync-byte and 0 otherwise). Once a “locked” packet alignment (synchronization) condition is reestablished, the absence of a valid checksum-encoded sync-byte word (47 Hex) at the expected location in the Serial Data Stream will indicate a packet error.

The False Lock Detector 540 detects a possible false lock condition by analyzing packet-derived information fed back from the transport layer 402 (e.g., including an MPEG Packet Parser 544 and/or an MPEG demultiplexer/decoder). The packet header bytes following the sync-byte candidate and/or the Program Specific Information are parsed in order to identify synchronization related problems in the transport block and instructs the Syndrome Detector 220-I to try and lock to another position identified using the parity check decoder (Syndrome Generator 210) and the Syndrome Detector 220-I until the correct sync-byte position is found. A false lock condition may be identified by examination of the supposed transport packet header fields (PID, continuity_counter, adaptation_field_control and transport_error_indicator), and/or by parsing supposed Program Specific Information.

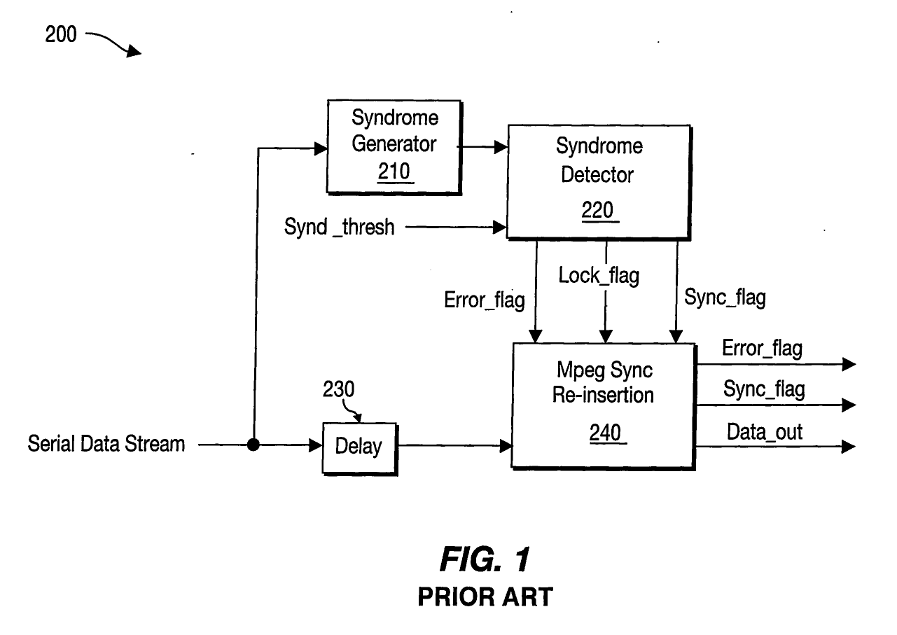

In FIG. 2, the MPEG framing block 200-I of the present invention is similar to the MPEG framing block 200 of the related art in FIG. 1, except for one additional input (skip_pattern_cntl) to the Syndrome Detector 220-I therein. The additional (skip_pattern_cntl) signal instructs the syndrome detector to ignore the current sync-like pattern to which it has locked to and to try to re-synchronize to the next sync-like pattern available within a packet length. The Syndrome Detector 220-I “skips” the current sync-like “pattern” and searches for the next sync-like pattern available in the output stream of the syndrome generator; it will then try to re-synchronize (lock) to the new sync-like pattern. Since there will typically be only a few sync-byte position candidates within a packet, this forced re-synchronization process can achieve a correct synchronization lock within a relatively small number of packets.

The False Lock Detector 540 generates and outputs the “skip” command (skip_pattern_cntl) to the Syndrome Detector 220-I in the framing block 200-I based upon information (e.g., from the Serial Data Stream) received via the physical layer. A false lock condition may be indicated by the occurrence of various events or non-occurrence of expected events in the transport layer 402 (e.g., in a MPEG-2 demultiplexer/decoder of the related art). The following are examples of events, the occurrence or non-occurrence of which may be used (e.g., by the False Lock Detector 540) to detect a false lock condition:

Anomaly 1=a PAT table has not been successfully received from the transport stream (e.g., PID=0×00 has not been detected);

Anomaly 2=A PMT table has not been successfully received from the transport stream;

Anomaly 3=a) an invalid PID is present in the data stream; or b) At least one of the PIDs in the PMT are not present in the stream; or

Anomaly 4=A discontinuity occurs in at least one of the continuity counters in the stream;

Anomaly 5=The Transport_error_indicator encoded in the supposed packet header is “1” appearing to indicate an uncorrectable bit error in the current transport packet while the MPEG-2 Error_flag output is “0”.

In a situation of a false synchronization lock: the search for a PAT (Anomaly 1) and/or PMT (Anomaly 2) will be compromised, since the fields contained in each of these tables, will not necessarily match with proper values; the PIDs (Anomaly 3) previously identified by a correct or by a corrupted PMT may not be found in the stream; an apparent discontinuity in a continuity counter (Anomaly 4) pertaining to at least one of the PIDs previously identified by a correct or by a corrupted PMT may occur; a transport_error_indicator (Anomaly 5) bit may be randomly set or be inconsistent with other information (e.g., the transport_error_indicator bit is ‘1’, when the error_flag signal is ‘0’).

In the False Lock Detector 540 of FIG. 2, signal lines labeled “flags” are used to carry information about significant events (e.g., Anomalies 1-5) between the MPEG Packet Parser 544 (e.g., an MPEG Demultiplexer/decoder) and the Decision Logic Block 542 of the False Lock Detector 540:

PAT_flag indicates Anomaly 1;

PAT_flag indicates Anomaly 2;

PID_flag indicates Anomaly 3a or Anomaly 3b;

cc_flag indicates Anomaly 4;

TE_flag indicates Anomaly 5.

The MPEG Packet Parser 544 generates the foregoing Anomaly-indicating flags (1-5) based upon parsing the contents of the Serial Data Stream (Data_out) and the other normal outputs (Error_flag, Sync_flag) from the MPEG framing (physical) layer 401. The MPEG Packet Parser 544 may be implemented by discrete anomaly-dedicated detection blocks (e.g., CC Verifier 548) or it may be implemented by an MPEG Demultiplexer/decoder of the related art.

The Decision Logic Block 542 receives, combines and filters the Anomaly flags (e.g., PID_flag etc.) that indicate the occurrence of the various Anomalies (1-5), to output the skip_pattern_cntl signal to the Syndrome Detector 220-I based upon a decision as to whether there probably exists a false lock condition.

The Decision Logic Block 542 may include state machines or other circuits adapted to perform hysteretic threshold filtering of one or more of the Anomaly Flags (1-5) and then pass the filtered Anomaly Flags to a flag combining circuit that generates a final decision in the form of the skip_pattern_cntl signal. The flag combining circuit within the Decision Logic Block 542 of the False Lock Detector 540 may include an OR-gate, an AND-gate, or a multiplexer, a microprocessor, a State Machine, a Latch, a Shift Register, or combinations of these and other elements known to persons skilled in the art.

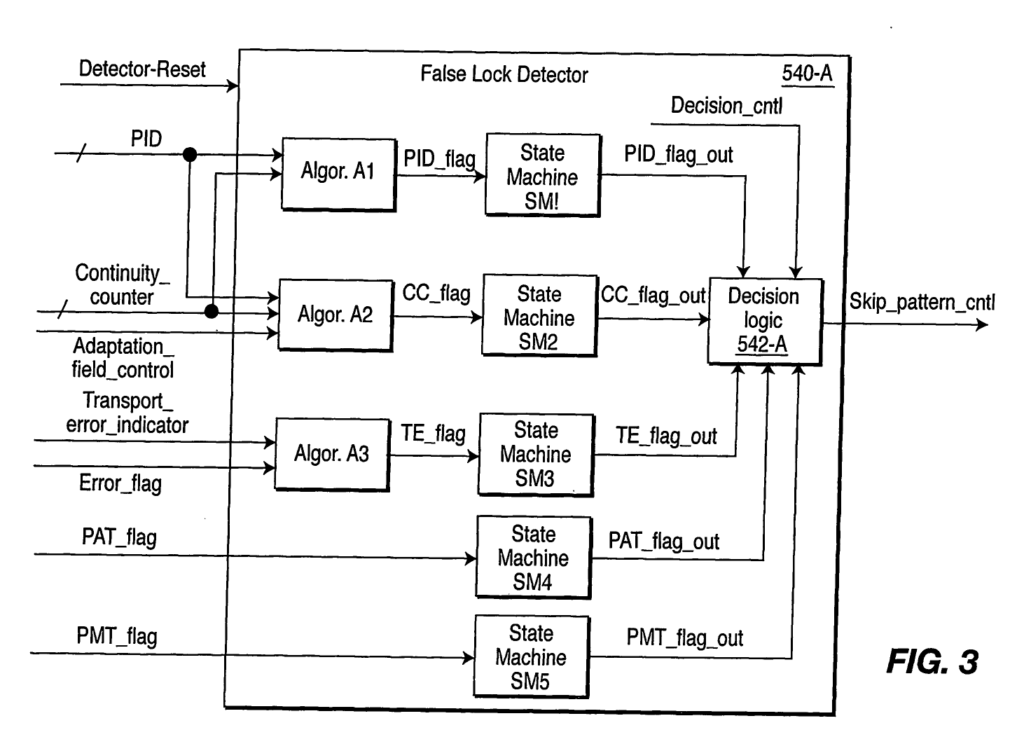

FIG. 3 is a block diagram showing a False Lock Detector 540-A according to another embodiment of the invention. False Lock Detector 540-A is similar to the False Lock Detector 540 of FIG. 2 in that it generates and outputs the skip_pattern_cntl command based upon information parsed from the Serial Data Stream (other than sync-byte location indicated by the Syndrome Detector 220-I). The False Lock Detector 540-A is adapted to detect a false synchronization lock condition of the Syndrome Detector 220-I of FIG. 2 and to output a command (skip_pattern_cntl) to the Syndrome Detector 220-I of FIG. 2 which is adapted to unlock and to try to locate another sync-byte position candidate indicated by the parity check block decoder (Syndrome Generator 210) and lock to that new position. This process of unlocking and resynchronization repeats until the correct sync-byte position is found (e.g., when no false lock condition is detected by the False Lock Detector 540-A).

The output (skip_pattern_cntl) of the False lock Detector block 540-A, is the same as the output (skip_pattern_cntl) of the similar False Lock Detector Block 540 of FIG. 2. False Lock Detector block 540-A can be implemented in either the physical layer (e.g., 401 of FIG. 2) or the transport layer (e.., 402 of FIG. 2). If implemented in the transport layer (402), many of its inputs (except for the Detector_Reset) are readily available packet header fields extractable from each packet in the transport (by an MPEG-2 demultiplexer/decoder) and only the output skip_pattern_cntl needs to be fed back to the physical layer (401). If implemented in the physical layer (401), all its inputs (except for the Detector_Reset) have to be fed back from the transport layer (402). The Detector_Reset input automatically resets all the algorithms (e.g., A1, A2, A3) and state machines (SM1, SM2, SM3, SM4, SM5) in the False Lock Detector 540-A and may be implement as a programmable bit register controlled by a (remote) microprocessor (not shown).

The False Lock Detector 540-A detects a possible false lock condition by analyzing information parsed from the Serial Data Stream (Data_out) that is output by the MPEG framing block 200-I, such as the Error_flag and bits parsed from the header of MPEG-2 Packets (e.g., supposed PID, continuity_counter, adaptation_field_control, transport_error indicator, etc.) from an MPEG demultiplexer/decoder of the related art.

The False Lock Detector 540-A may include a plurality of circuits (A1, A2, A3) adapted to perform, in parallel, a plurality of detection algorithms upon the information received (e.g., from the MPEG demultiplexer/decoder), as follows:

### Algorithm A1: Expected PID Not Found

Algorithm A1 detects Anomaly 3b as follows: The continuity_counters for a given PMT are cc(n,k), 0≦n<N, k≧0, where n represents a distinct PID (e.g., PID=n) in a PMT, NPID is the total number of distinct PID's in a PMT and k represents packet count. For a particular program, hence PMT, the transport demultiplexer creates one continuity counter per each distinct PID. The algorithm creates a flag for each continuity counter, cc_pid(n), 0≦n<N, that are originally set to ‘1’ and are only set to ‘0’ after cc(n,k) has incremented for the first time (when the first packet having a particular PID value listed in the PMT is detected). The algorithm runs indefinitely (if not reset by a Detector_Reset) and outputs PID_flag(k) for each value of k≧0. The value of PID_flag(k) is ‘1’ as long as there is at least one flag cc_pid(n) for which its value is ‘1’. This algorithm flags a possible false lock condition, since it means that at least one of the expected PID's in a supposed PMT are not available in the stream:

1. Set k=0.

2. Set cc_pid(n)=1, for 0≦n<NPID.

3. If ((cc(n, k)=1) and (cc_pid(n)=1)), then cc_pid(n)=0, for 0<n≦NPID.

4. Set PID_flag(k)=OR[cc_pid(n), for 0≦n<NPID].

5. Set k=k+1. Go to 3.

### Algorithm A2: Continuity_counter Anomaly

Algorithm A2 detects Anomaly 4 as follows: The continuity_counters for a given PMT are cc(n,k), 0≦n<NPID, k≧0, where n represents a distinct PID (PID=n) in a PMT, NPID is the total number of distinct PID's in a PMT and k represents packet count. For a particular program, hence, PMT, the transport demultiplexer creates one continuity counter per distinct PID. The algorithm runs indefinitely (if not reset by a Detector_Reset) and outputs cc_flag(k) for each value of k. The value of cc_flag(k) is ‘1’ when a discontinuity is detected in one of the counters. This algorithm flags a possible false lock condition:

1. Set k=0.

2. Set cc flag(k)=0.

3. If ((adaptation_field_control=‘00’) or (adaptation_field_control=‘10’)), then go to 6.

4. Else if ((adaptation_field_control=‘01’ or adaptation_field_control=‘11’) and ( ( (cc(n,k)>cc(n,k−1)) and (cc(n,k−1)<15) ) or (cc(n,k)=cc(n,k−1)) or ( (cc(n,k)=0) and (cc(n,k−1)=15) ), for 0≦n<NPID, k>0), then go to 6.

5. Else, set cc_flag(k)=1.

6. Set k=k+1. Go to 2.

### Algorithm A3: TEI Anomaly

Algorithm A3 detects Anomaly 5 as follows: The algorithm runs indefinitely (if not reset by a Detector_Reset) and outputs TE_flag(k) for each value of k, where k represents packet count. The value of TE_flag(k) is ‘1’ when the recovered transport_error_indicator (TEI) is ‘1’, while the MPEG framing block error_flag indicates no errors in the physical layer. This indicates a possible false lock condition. It is possible for the transmitter to send an MPEG-2 stream with the transport_error_indicator already set to ‘1’, indicating prior error in the data generation. Although that means that the transport will discard this packet anyway, a possible false lock condition may be indicated when many of these anomalies appear in the transport stream:

1. Set k=0.

2. Set TE_flag(k)=0;

3. If ((transport_error_indicator=1) and (error_flag=0)) then set TE_flag(k)=1.

4. Set k=k+1. Go to 2.

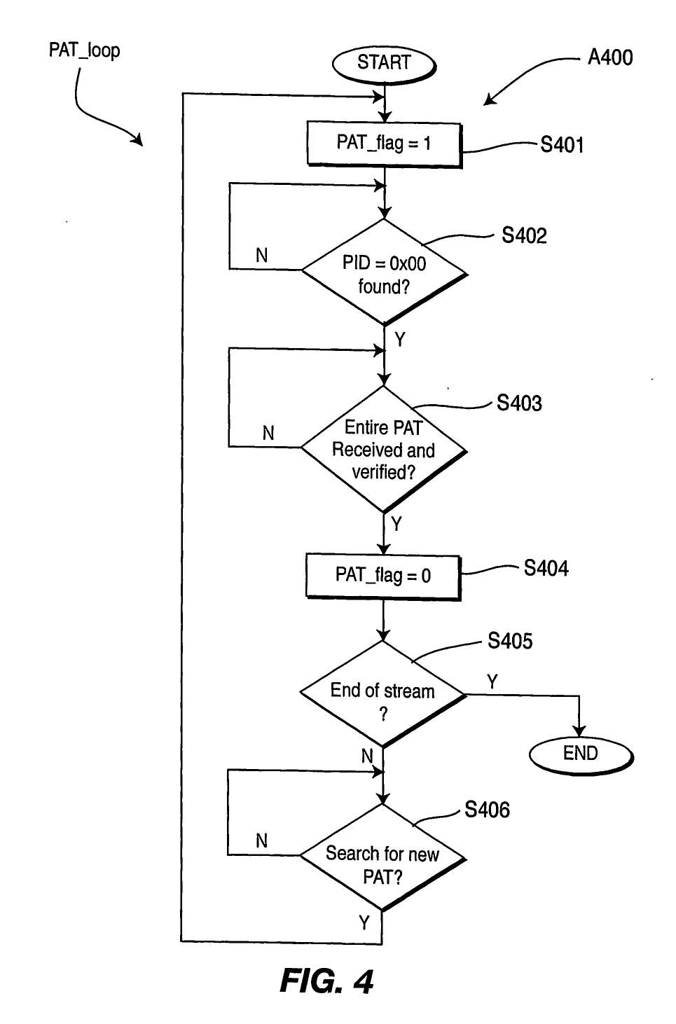

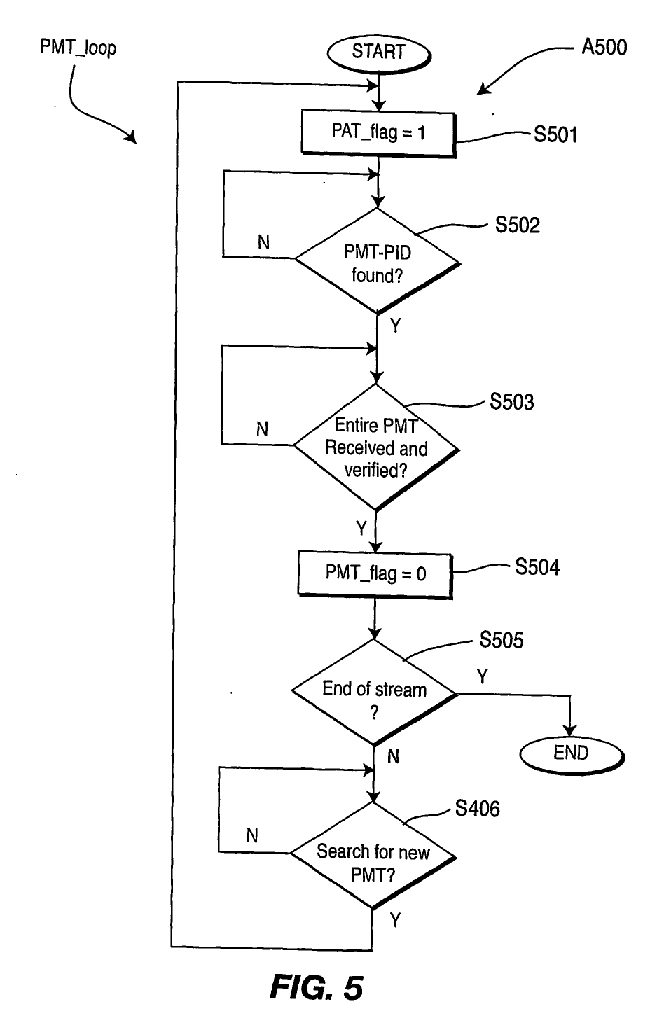

To increase the reliability and stability of the output (skip_pattern_cntl) of the False Lock Detector 540-A, state machines (e.g., SM1, SM2, SM3) may be provided so as to capture the Anomaly-flag output of each Algorithm block (A1, A2, A3) and to provide a hysteretic thresholding characteristic to each Anomaly-flag (PID_flag, cc_flag, TE_flag) as well as PAT_flag and PMT_flag (see FIGS. 4 and 5). Assuming that an Anomaly-flag value of “0” indicates the absence of a detected anomaly (e.g., the nominal condition during a true synchronization lock): Each state machine m (m=1, 2 3, 4, or 5), may count for a programmable number of packets, Npackets(m), that event that its input flag (e.g., PID_flag for m=1, cc_flag for m=2, TE_flag for m=3, PAT_flag for m=4 or PMT_flag for m=5) is ‘0’ for a number greater than or equal to a number of threshold packets, lock_in_thresh(m), before outputting a flag (e.g., PID_flag_out, cc_flag_out, TE_flag_out, indicating the absence of Anomaly 3, Anomaly 4, Anomaly 5 respectively), Thereupon, the output flag (PID_flag_out for m=1, cc_flag_out for m=2, or TE_flag_out for m=3, PAT_flag_out for m=4, or PAT_flag_out for m=5) for each state machine would be set to ‘0’, to indicate the absence of a particular anomaly. Once output flag of a state machine is ‘0’, it counts for a programmable number of packets, Npackets(m), whether its input flag is ‘1’ (indicating the occurrence of an anomaly, e.g., Anomaly 1, Anomaly 2, Anomaly 3, Anomaly 4, Anomaly 5 respectively), for a number greater than or equal to a number of threshold packets, lock_out_thresh(m), before declaring the detection of an anomaly which may indicate the loss of synchronization lock (i.e., a false lock), whereupon state machine's output flag is set to ‘1’. Other variations of this state machine operations are possible.

The Decision Logic Block 542-A which generates the skip_pattern_cntl command output by the False Lock Detector 540-A may be multi-modal, the particular mode being dynamically selected according to the value of a programmable control signal, decision_cntl. For example, in different modes, the Decision Logic Block 542-A may function as a three-input OR-gate; a five-input OR-gate; a three-input AND-gate, etc., or multiplexer with respect to the outputs of the hysteretic thresholding filters (SM1, SM2, SM3, SM4, SM5). For example, the False Lock Detector 540-A could function as a five-input OR-gate (e.g., for decision_cntl=0) or a five-input AND-gate (e.g., for decision_cntl=1). In addition, the False Lock Detector 540-A could be a five-input multiplexer controlled by decision_cntl=2, 3, 4, 5, or 6 selecting, respectively, PID_flag_out, cc_flag_out, TE_flag_out, PAT_flag_out, or PMT_flag_out, as the multiplexer's output. Other variations of these settings are possible.

FIG. 4 is a flowchart describing an algorithm A400 performed to generate the PAT_flag used by the Decision Logic Blocks 542 and 542-A of FIGS. 2 and 3 respectively according to an embodiment of the present invention.

In each flowchart (e.g., FIGS. 4, and 5), “Y” denotes “YES” and marks the branch of a decision step that is used when the comparison or statement indicated within the associated diamond (decision block) is TRUE. Conversely, “N” denotes “NO” and marks the branch of a decision step that is used when the comparison or statement indicated within the associated diamond (decision block) is FALSE.

The algorithm A400 of FIG. 4 comprises a loop PAT_loop that begins at the Start and that repeats each time a (new) PAT is due to be detected, until the end of the received Serial Data Steam (S405) is detected (e.g., “End of Stream?” equals “YES”), and includes steps (S401, S402, S403, S404, S405, and S406) that are performed for each cycle of the loop.

The Start corresponds generally to a nominal condition of a flow of a supposedly valid synchronized Serial Data Stream out of the framing block 200-I during a supposedly true synchronization lock, and/or to the initialization of the False Lock Detector (540 and 540-A) using the Detector_Reset input

In initialization step S401 (the first step of PAT_loop), which follows the Start, the PAT_flag is initialized to ‘1’. The PAT_flag when set to ‘0’ indicates that a (valid) PAT table has been successfully received from the transport stream; when set to ‘1’, it indicates that the table has not (yet) been successfully received from the transport stream. At start-up of the MPEG-2 receiver system, the PAT_flag is set to ‘1’ (and will change to “0” after a valid PAT is acquired).

Step S402 is a wait step implemented as a decision branch step in which the initialized value of PAT_flag is maintained (PAT_flag=‘1’) until at least a supposed PID (packet ID) having value ‘0’ is found (detected).

The next step S403, is a decision branch step in which the initialized value of PAT_flag is maintained (PAT_flag=‘1’) until all the packets having PID=0×00 and containing a section of the PAT table can be “verified” as containing a seemingly valid (e.g., non-corrupted) PAT. During step S403 the MPEG demultiplexer/decoder (or the MPEG Packet Parser 544 of FIG. 2) may parse the packets bearing PID (packet ID)=0, in order to detect an entire valid PAT. Step S403 is performed until an entire PAT has been deemed valid. Step S403 is performed until a PAT has been deemed “verified” (Y), whereupon next step S404 is performed and PAT_flag is set to ‘0.’

Verification of the PAT may be superficial, or extensive, in various alternative embodiments of the invention. In some embodiments of the invention, the PAT verification step S403 may include simply verifying that all “sections” of a PAT have been received. In some embodiments of the invention, the PAT verification step S403 may be practically eliminated such that next step S404 is performed immediately upon the detection of one or more expected bit patterns, such as the pattern of the 13 bits of the PID.

Step S405 is a decision branch step of detecting (Y) or not detecting (N) the End of the Data Stream output from the MPEG framing block 200-I of FIG. 2, which upon being detected (Y) would terminate (End) the loop PAT_loop; if the End of the Data Stream is not detected (N) in step S405, then loop PAT_loop continues to repeat and step S406 is next performed, and PAT_flag will be reinitialized (to “1”) in step S401.

Step S406 is a wait step implemented as a decision branch step in which the determined value of PAT_flag is maintained (PAT_flag=‘0’) until a new PAT table is due (expected). Thus, the PAT_flag is set to “1” every time a new PAT is being sought (due) and it is only set to “0” when the PAT has been acquired.

The value of PAT_flag may be sampled and if the time between the initialization step S401 (PAT_flag=‘1’) and the step in which the Flag indicates a valid PAT packet has been received (PAT_flag=‘0’) exceeds a predetermined timing threshold, the sampled value PAT_flag=‘1’ will be output to the Decision Logic Block (542, 542-A) of the False Lock Detector (540, 540-A) to indicate the occurrence of Anomaly 1. The sampling of PAT_flag may be timed to correspond to when a (new) PAT has been due for the predetermined time (threshold), by measuring the (sample period) time from the point when a new PAT table is determined to be due (the Y branch in wait step S406).

FIG. 5 is a flowchart describing an algorithm A500 performed to generate the PAT_flag used by the Decision Logic Blocks 542 and 542-A of FIGS. 2 and 3 respectively according to an embodiment of the present invention.

The algorithm A500 of FIG. 5 comprises a loop PMT_loop that begins at the Start and that repeats each time a (new) PMT is due to be detected, until the end of the received Serial Data Steam (S505) is detected (e.g., “End of Stream?” equals “YES”), and includes steps (S501, S502, S503, S504, S505, S506 and S507) that are performed for each cycle of the loop.

The Start corresponds generally to a nominal condition of a flow of a supposedly valid synchronized Serial Data Stream out of the framing block 200-I during a supposedly true synchronization lock, and/or to the initialization of the False Lock Detector (540 and 540-A) using the Detector_Reset input

In initialization step S501 (the first step of PMT_loop), which follows the Start, the PMT_flag is initialized to ‘1’. The PAT_flag when set to ‘0’ indicates that a (valid) PMT has been successfully received from the transport stream; when set to ‘1’, it indicates that the PMT has not (yet) been successfully received from the transport stream. At start-up of the MPEG-2 receiver system, the PMT_flag is set to ‘1’ (and will change to “0” after a valid PMT is acquired).

Step S502 is a wait step implemented as a decision branch step in which the initialized value of PAT_flag is maintained (PAT_flag=‘1’) until at least a PID (packet ID) having an expected value (derived from a PAT) is found (detected).

The next step S503, is a decision branch step in which the initialized value of PMT_flag is maintained (PAT_flag=‘1’) until all the packets detected as having a PMT-PID can be “verified” as received containing a (seemingly) valid (e.g., non-corrupted) PMT. During step S503 the MPEG demultiplexer/decoder (or the MPEG Packet Parser 544 of FIG. 2) may parse the packets bearing a PMT-PID, in order to detect an entire valid PMT. Step S503 is performed until a PMT has been deemed “verified” (Y), whereupon next step S504 is performed and PAT_flag is set to ‘0.’ Verification of the PMT may be superficial, or extensive, in various alternative embodiments of the invention. In some embodiments of the invention, the PMT verification step S503 may include simply the detection of an entire PMT (including the last byte of a PMT). In some embodiments of the invention, the PMT verification step S503 may be practically eliminated such that next step S504 is performed immediately upon the detection of one or more expected bit patterns, such as the pattern of the 13 bits of the PMT-PID.

Step S505 is a decision branch step of detecting (Y) or not detecting (N) the End of the Data Stream output from the MPEG framing block 200-I of FIG. 2, which upon being detected (Y) would terminate (End) the loop PMT_loop; if the End of the Data Stream is not detected (N) in step S505, then loop PMT_loop continues to repeat and step S506 is next performed, and PMT_flag will be reinitialized (to “1”) in step S501.

Step S506 is a wait step implemented as a decision branch step in which the determined value of PMT_flag is maintained (PMT_flag=‘0’) until a new PMT is due (expected). Thus, the PMT_flag is set to “1” every time a new PMT is being sought (due) and it is only set to “0” when the PMT has been acquired.

The value of PMT_flag may be sampled and if the time between the initialization step S501 (PMT_flag=‘1’) and the step in which the Flag indicates a valid PMT packet has been received (PMT_flag=‘0’) exceeds a predetermined timing threshold, the sampled value PMT_flag=‘1’ will be output to the Decision Logic Block (542, 542-A) of the False Lock Detector (540, 540-A) to indicate the occurrence of Anomaly 2. The sampling of PAT_flag may be timed to correspond to when a (new) PMT has been due for the predetermined time (threshold), by measuring the (sample period) time from the point when a new PMT table is determined to be due (the Y branch in wait step S506).

In summary, the PMT_flag when set to “0” indicates that a PMT table has been successfully received from the transport stream; when set to “1”, it indicates that the table has not (yet) been successfully received from the transport stream. At start-up (Start) of the MPEG-2 receiver system, the PMT_flag is set to “1”. Furthermore, the PMT_flag is set to “1” every time a new program (hence, a new PMT) is being sought and it is only set to “0” when the PMT has been acquired.

The foregoing description merely illustrates the principles of the invention. It will be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or other processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage. Other hardware, conventional and/or custom, may also be included. Similarly, any switches, gates, or multiplexers described or shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means that can provide those functionalities as equivalent to those shown herein.

These and other features of the present invention may be readily ascertained by one of ordinary skill in the pertinent art based on the principles disclosed herein. It is to be understood that the principles of the present invention may be implemented in various forms of hardware, software, firmware, special purpose processors, or combinations thereof.

The present invention is implemented as a combination of hardware and software. Moreover, a software implementation may be implemented as an application program tangibly embodied on a program storage unit or fixed media. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU.

Exemplary embodiments of the invention have been explained above and are shown in the figures. However, the present invention is not limited to the exemplary embodiments described above, and it is apparent that variations and modifications can be effected by those skilled in the art within the spirit and scope of the present invention.

It is to be further understood that, because some of the constituent system components and methods depicted in the accompanying drawings may be implemented in software (e.g., adapted to be executed by a personal computer or a set-top box), the actual connections between the system components or the method blocks may differ depending upon the manner in which the software programmed to implement the present invention is programmed. Given the principles of the present invention disclosed herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

Therefore, the exemplary embodiments should be understood not as limitations but as examples. The scope of the present invention is not determined by the above description but by the accompanying claims, and variations and modifications may be made to the embodiments of the invention without departing from the scope of the invention as defined by the appended claims and equivalents.

1. An apparatus processing a stream of fixed-length packets received as digitally encoded signals and having multiple packet types, each packet including a header portion, the header portion containing a checksum-encoded synchronization-byte, the apparatus comprising:
a synchronization-byte detector for detecting position-candidates of a checksum-encoded synchronization-byte in each packet, and for periodically outputting a synchronization-byte position signal at a first detected position within each packet, wherein the Synchronization Detector is adapted to respond to a “resync” command signal by trying to detect a checksum-encoded sync-byte in a second position within each packet.

2. The apparatus of claim 1, further comprising a False Lock Detector adapted to generate and assert the “resync” command signal because at least one predefined anomaly condition that indicates a possible false-lock condition has been detected.

3. The apparatus of claim 2, wherein the False Lock Detector is adapted to assert the “resync” command signal because a first predefined anomaly condition, characterized by a MPEG-2 PAT table having not been detected in the stream, has been detected.

4. The apparatus of claim 2, wherein the False Lock Detector is adapted to assert the “resync” command signal because a second predefined anomaly, characterized by an expected MPEG-2 PMT table having not been detected in the transport stream, has been detected.

5. The apparatus of claim 2, wherein the False Lock Detector is adapted to assert the “resync” command signal because a predefined anomaly, characterized by a supposed MPEG-2 PAT table containing invalid information, has been detected.

6. The apparatus of claim 2, wherein the False Lock Detector is adapted to assert the “resync” command signal because a predefined anomaly, characterized by a supposed MPEG-2 PMT table containing invalid information, has been detected.

7. The apparatus of claim 2, wherein the False Lock Detector is adapted to assert the “resync” command signal because a third predefined anomaly, characterized by at least one of the MPEG-2 PID's listed in a MPEG-2 PMT having not been detected in the stream, has been detected.

8. The apparatus of claim 2, wherein the False Lock Detector is adapted to assert the “resync” command signal because a fourth predefined anomaly, characterized by a discontinuity in at least one MPEG-2 continuity counter for MPEG-2 packets in the stream, has been detected.

9. The apparatus of claim 2, wherein the False Lock Detector is adapted to assert the “resync” command signal because a fifth predefined anomaly, characterized by the MPEG-2 transport_error_indicator bit encoded in a MPEG-2 packet's header being “1” while the MPEG-2 Error_flag is “0”, has been detected.

10. The apparatus of claim 2, wherein the synchronization-byte detector is adapted to respond to a “resync” command signal by skipping the current detected sync-byte position and then by trying to detect the next position-candidate of a checksum-encoded synchronization-byte using the conventional checksum detection process.

11. The apparatus of claim 1, further comprising a Decision Logic circuit adapted to generate the “resync” command signal in response to the detection of a dynamically defined selection of one or more of the following anomaly conditions a) through e):
a) a MPEG-2 PAT table has not been detected in the stream;
b) a MPEG-2 PMT table has not been detected in the stream
c) at least one of the MPEG-2 PID's listed in a MPEG-2 PMT has not been detected in the stream;
d) a discontinuity in at least one MPEG-2 continuity counter for MPEG-2 packets in the stream has been detected;
e) the value of the MPEG-2 transport error_indicator bit detected in a MPEG-2 packet's header is “1” while the MPEG-2 Error_flag bit is “0.”

12. An apparatus for processing a stream of fixed-length packets received as digitally encoded signals and having multiple packet types, each packet including a header portion, the header portion containing a checksum-encoded synchronization-byte, the apparatus corn rising:
a False Lock Detector adapted to generate a “resync” command signal because at least one predefined anomaly condition that indicates a possible false-lock condition has been detected.

13. The apparatus of claim 12, further comprising a synchronization-byte detector for detecting position-candidates of a checksum-encoded synchronization-byte in each packet, and for periodically outputting a synchronization-byte position signal at a first detected position within each packet, wherein the Synchronization Detector is adapted to respond to the “resync” command signal by trying to detect and to “lock” to a checksum-encoded sync-byte in a second position within each packet.

14. The apparatus of claim 13, wherein the False Lock Detector is adapted to generate and assert the “resync” command signal because at least one of the following predefined anomaly conditions, has been detected:
f) a MPEG-2 PAT table has not been detected in the stream;
g) a MPEG-2 PMT table has not been detected in the stream
h) at least one of the MPEG-2 PID's listed in a MPEG-2 PMT has not been detected in the stream;
i) a discontinuity in at least one MPEG-2 continuity counter for MPEG-2 packets in the stream has been detected;
j) the value of the MPEG-2 transport error_indicator bit detected in a MPEG-2 packet's header is “1” while the MPEG-2 Error_flag bit is “0.”

15. The apparatus of claim 14, wherein the False Lock Detector includes a Decision Logic circuit adapted to select at least one of anomaly conditions a) through e) as a causal basis of the “resync” command signal to be generated and asserted by the False Lock Detector.

16. The apparatus of claim 14 wherein the False Lock Detector includes a filter that implements hysteresis thresholding of anomaly-indicating flag values that are based upon parsing the MPEG-2 packets in the Stream as delineated by the synchronization-byte detector.

17. The apparatus of claim 16 wherein the filter is implemented by a finite state machine.

18. The apparatus of claim 14 wherein the False Lock Detector includes a MPEG-2 demultiplexer/decoder of the related art.

19. The apparatus of claim 14 wherein the False Lock Detector includes MPEG-2 Packet Parser adapted to parse MPEG-2 packets in the stream.

20. The apparatus of claim 19 wherein the MPEG-2 Packet Parser is adapted to generate anomaly-indicating flag values based upon parsing the MPEG-2 packets in the Stream as delineated by the synchronization-byte detector.

21. The apparatus of claim 19 wherein the MPEG-2 Packet Parser includes at least one dedicated anomaly-detecting circuit.

22. The apparatus of claim 19 wherein the MPEG-2 Packet Parser includes a first comparator, adapted to compare the MPEG-2 PID of a packet delineated by the synchronization-byte detector, with a table of expected PID values.

23. The apparatus of claim 20 wherein the False Lock Detector further includes a Decision Logic circuit adapted to select at least one of anomaly flags as a causal basis of the “resync” command signal to be generated and asserted by the False Lock Detector.

24. The apparatus of claim 12 wherein the “resync” command signal restarts the conventional process of detecting a checksum-encoded sync-byte position within the packets in the stream.

25. The apparatus of claim 13 further comprising an MPEG Sync-Byte Re-insertion circuit for inserting a predetermined value into the sync-byte position indicated by the synchronization-byte detector.

26. The apparatus of claim 13, wherein the synchronization-byte detector is an MPEG-2 sync-byte detector that includes a Syndrome Detector for detecting a checksum-encoded sync-byte.

27. A method for processing a stream of fixed length packets each packet containing a checksum-encoded sync-byte, the stream including a plurality of packets that each contain a first fixed bit pattern in the header portion of each packet, the method comprising:
performing a first detection step of decoding the checksum in the stream to detect a checksum-encoded sync byte position-candidate in the stream; and
performing a false lock detection step including detecting at least one anomaly that indicates a possible false synchronization lock; and then
performing a second detection step of decoding the checksum in the stream to detect a second checksum-encoded sync byte position-candidate in the stream.

28. The method of claim 27, further comprising the intermediate step of generating a “resync” command signal having a value indicating that a possible false synchronization lock has been detected, and outputting that “resync” flag signal value to a synchronization-byte detector adapted to respond to the “resync” command signal value by trying to detect and resynchronize to the next position-candidate of a checksum-encoded synchronization-byte using the conventional checksum detection process.

29. The method of claim 28, wherein the “resync” command signal value depends upon at least one anomaly-indicating flag value.

30. The method of claim 27 wherein the anomaly-indicating flag value depends upon one of the following anomaly conditions having been detected:
b. at least one of the MPEG-2 PID's listed in a MPEG-2 PMT has not been detected in the stream;
c. a discontinuity in at least one MPEG-2 continuity counter for MPEG-2 packets in the stream has been detected; or
d. the value of the MPEG-2 transport_error_indicator bit in a MPEG-2 packet's header is “1” while the MPEG-2 Error_flag is “0”.

31. The method of claim 27, wherein performing the false lock detection step further includes performing at least one anomaly-detecting substep of detecting a first anomaly that indicates a possible false synchronization lock by parsing at least one of the packets.

32. The method of claim 27, wherein performing the false lock detection step further includes performing at a plurality of anomaly-detecting substeps wherein a plurality of anomalies that each indicate a possible false synchronization lock are detectable by parsing at least one of the packets.

33. The method of claim 32, wherein the plurality of anomalies includes:
e. at least one of the MPEG-2 PID's listed in a MPEG-2 PMT has not been detected in the stream;
f. a discontinuity in at least one MPEG-2 continuity counter for MPEG-2 packets in the stream has been detected; and
g. the value of the MPEG-2 transport_error_indicator bit in a MPEG-2 packet's header is “1” while the MPEG-2 Error_flag is “0”.

34. The method of claim 32 wherein the anomaly-indicating flag value depends upon one of the following anomaly conditions having been detected:
a) a MPEG-2 PAT table has not been detected in the stream;
b) a MPEG-2 PMT table has not been detected in the stream;
c) at least one of the MPEG-2 PID's listed in a MPEG-2 PMT has not been detected in the stream;
d) a discontinuity in at least one MPEG-2 continuity counter for MPEG-2 packets in the stream has been detected;
e) the value of the MPEG-2 transport_error_indicator bit detected in a MPEG-2 packet's header is “1” while the MPEG-2 Error_flag is “0”.

35. The method of claim 27 further comprising the step of inserting a predetermined sync-byte value into the first detected checksum-encoded sync byte position-candidate, and after performing false lock detection step, then performing the step of inserting the predetermined sync-byte value into the second detected checksum-encoded sync byte position-candidate.

36. The method of claim 27, further comprising:
performing a synchronization-lock step of delineating the packet boundaries of a plurality of packets based upon the position of the second detected sync-byte position candidate; and
performing the insertion step of inserting a predetermined sync-byte value into the second detected sync-byte position candidate in each of the plurality of packets.

37. A computer program product for a set-top-box that comprises a set of instructions, which, when loaded into the set-top-box, causes the set-top-box to carry out the method, for processing a stream of fixed length packets, claimed in claim 27.

38. A computer program product for a television set that comprises a set of instructions, which, when loaded into the television set, causes the television set to carry out the method, for processing a stream of fixed length packets, claimed in claim 27.
